(19) United States
(12) Patent Application Publication
(10) Pub. No.: US 2026/0071073 A1
(43) Pub. Date: Mar. 12, 2026

(54) METHOD FOR PREPARING HIGH-PURITY GARDENIA YELLOW PIGMENT

(71) Applicant: HENAN ZHONGDA HENGYUAN BIOTECHNOLOGY STOCK CO., LTD., Luohe City (CN)

(72) Inventors: Ziheng JIN, Luohe City (CN); Yanjun WEN, Luohe City (CN)

(21) Appl. No.: 19/264,228

(22) Filed: Jul. 9, 2025

(30) Foreign Application Priority Data
Sep. 9, 2024 (CN) 202411255170.4

(51) Int. Cl. C09B 61/00; B01D 1/22; B01D 11/02; B01D 15/42; B01D 21/26; C09B 67/54

(52) U.S. Cl. CPC C09B 61/00; B01D 1/222; B01D 11/0203; B01D 11/0288; B01D 11/0292; B01D 15/426; B01D 21/262; C09B 67/0096

(57) ABSTRACT

A method for preparing high-purity gardenia yellow pigment includes: taking gardenia fruit, performing degreasing and impurity removal treatment on gardenia dry powder, and preparing a crude extract of gardenia dry powder by supercritical fluid extraction combined with a pre-formulated pigment carrier. A pigment adsorption resin is then prepared, followed by wet column packing of the pigment adsorption resin. The crude pigment extract is loaded onto the column for adsorption, and the pigment is eluted using a 45% ethanol solution, separating the yellow pigment solution and impurity solution. By employing the degreasing and impurity removal treatment of gardenia dry powder, and using the pigment adsorption resin to purify the crude pigment extract, the invention achieves a high-purity and high-color-value gardenia yellow pigment, while also enabling the separation of gardenia glycoside and chlorogenic acid from the gardenia yellow pigment.

This application claims priority to Chinese Patent Application No. 202411255170.4, filed on Sep. 9, 2024, which is incorporated by reference for all purposes as if fully set forth herein.

### TECHNICAL FIELD

The present invention belongs to the field of pigment extraction technology and specifically relates to a preparation method for high-purity gardenia yellow pigment.

### BACKGROUND

Gardenia is a plant resource that is both edible and medicinal, and it can be divided into two types: water gardenia, which is used for pigment extraction, and mountain gardenia, which is used as medicinal gardenia. Additionally, gardenia is widely used as a food coloring agent and in the preparation of health food such as porridge and tea. The various chemical components of gardenia have the ability to lower blood sugar levels, reduce blood lipids, protect the liver and gallbladder, and promote pancreatic secretion.

Gardenia yellow pigment is a water-soluble natural pigment mainly extracted from gardenia fruit. Its appearance is orange-yellow, and it is soluble in water, ethanol, and propylene glycol. It has been widely used and its extraction mainly involves direct solvent extraction of active substances. However, the purity of the extracted pigment cannot be guaranteed using current methods, and the extraction process is time-consuming.

Chinese patent CN102898864B disclosed a method for purifying gardenia yellow pigment using solvent crystallization, which includes the following steps: adding solvent A to the crude gardenia yellow pigment, stirring the mixture at 10-30° C. to dissolve the crude gardenia yellow pigment, or heating it to 35-100° C. to dissolve the crude pigment, and then filtering to obtain the filtrate. The composition of solvent A is: 70-100% hydrophilic organic solvent and 0-30% water. The filtrate is then crystallized and dried to obtain gardenia yellow. However, the existing method using solvent crystallization is time-consuming, results in a low yield, and cannot separate impurities like gardenia polysaccharides. The gardenia polysaccharides in the crude gardenia yellow pigment can affect the color, quality, and activity of the pigment, leading to reduced purity. To address these issues, we propose a method for preparing high-purity gardenia yellow pigment.

### SUMMARY OF THE INVENTION

The objective of the present invention is to provide a preparation method for high-purity gardenia yellow pigment, addressing the shortcomings of the prior art. This method solves the problems of long extraction time and low yield when using solvent crystallization purification, as well as the inability to separate impurities such as gardenia polysaccharides, which lead to reduced purity of gardenia yellow pigment.

The invention is achieved by a preparation method for high-purity gardenia yellow pigment, which specifically includes:
Take gardenia fruits, wash the gardenia fruits 3-5 times using ultrapure water, then place the gardenia fruits in a blast drying oven at 40° C. for 45 hours. After drying, grind the fruits into 100-mesh gardenia dry powder using a B-type universal pulverizer. Perform degreasing and impurity removal treatment on the gardenia dry powder, and set aside;
Pre-formulate the pigment carrier, and combine the pre-formulated pigment carrier with the gardenia dry powder using supercritical fluid extraction to obtain a crude pigment extract. Remove the pigment carrier from the crude pigment extract using rotary evaporation. Add an equal volume of ultrapure water to the crude pigment extract to obtain the crude pigment solution;
Prepare the pigment adsorption resin, and load the prepared pigment adsorption resin onto a column by wet packing. Load the crude pigment extract onto the column for adsorption, and elute with a 45% ethanol solution, separating the yellow pigment solution from the impurity solution;
Take the impurity solution, prepare a purification extracting agent, and mix the purification extracting agent with the impurity solution at a volume ratio of 10:3. Then, extract and purify chlorogenic acid from the impurity solution. The extraction time is 3-10 minutes, and then use a stripping agent for 2-10 stages of countercurrent stripping to obtain a gardenia glycoside solution that separates chlorogenic acid.

As a preferred embodiment, the pigment carrier comprises the following raw materials in weight percentage:
Ethanol: 65%;
Acetone: 10%;
Ether: 15%;
Ethyl acetate: 10%.

The method for pre-formulating the pigment carrier specifically includes:
Take ethyl acetate, and under an argon-protected environment, add acetone to the ethyl acetate to obtain the first component of the carrier;
Under a 30° C. environment, add acetone dropwise to the first component of the carrier. After the addition is complete, stir and mix for 2 minutes, then let it stand for 10 minutes to obtain the second component of the carrier;
Take the second component of the carrier, and under an inert gas environment, add ether to the second component of the carrier. Stir at 10-20 r/min for 5 minutes to obtain the pigment carrier, then store the pigment carrier at 20° C. for later use.

As a preferred embodiment, the method for extracting crude gardenia dry powder based on supercritical fluid extraction combined with the pre-formulated pigment carrier specifically includes:
Take the degreased and impurity-removed gardenia dry powder, place the gardenia dry powder into a supercritical extractor, seal the lid, and set the extraction temperature to 50° C.;
Open the carbon dioxide cylinder and compressor, set the extraction pressure to 30 MPa, and set the auxiliary microwave power to 300 W;
Once the temperature reaches 50° C., stabilize for 5 minutes, then introduce carbon dioxide and the pre-formulated pigment carrier into the supercritical extractor, and perform a cyclic extraction for 15 minutes, where the carbon dioxide flow rate is set to 3-3.5 L/min and the pigment carrier flow rate is set to 0.4-0.5 mL/min;
After the extraction, let the supercritical extractor stand for 10 minutes, collect the discharge liquid from the outlet of the supercritical extractor, centrifuge at 300-350 r/min for 15 minutes to remove the residue at the bottom of the discharge liquid, then use rotary evaporation to remove the pigment carrier from the discharge liquid to obtain the crude pigment extract.

As a preferred embodiment, the method for degreasing and impurity removal of the gardenia dry powder specifically includes:
Take the gardenia dry powder, mix it with a 1:1 mixture of petroleum ether and n-hexane at 10 times the volume of the dry powder in an evaporating dish, and suspend it. Place the evaporating dish in a constant temperature water bath for 3 hours, maintaining the water bath temperature at 65-70° C. Stir manually every 15 minutes, and replace the same volume of petroleum ether and n-hexane every 30 minutes;
Filter the gardenia dry powder from the suspension in the evaporating dish using a sieve, discard the supernatant, and retain the residue;
Place the residue into a blast drying oven at 75° C. for 10 minutes, then lower the temperature of the blast drying oven to 40° C. and dry for 2 hours to obtain the pre-degreased dry powder.

As a preferred embodiment, the method for degreasing and impurity removal of the gardenia dry powder further includes:
Take the pre-degreased dry powder, and grind it using precooled liquid nitrogen. After grinding, place the dry powder in a reactor. Add 10 times the volume of sodium dodecyl sulfate to the reactor, mix thoroughly, then add 3 times the volume of phenol. Let it stand for 10 hours, then perform extraction on the mixture in the reactor. Discard the organic phase and the supernatant, and collect the dry powder precipitate. Dry the dry powder precipitate in a blast drying oven at 60° C. for 20 minutes;
Place the dry powder precipitate into a reaction tube, then add 12 times the mass of the dry powder precipitate of 95% ethanol for soaking. Soak for 48 hours, and after soaking, place the dry powder precipitate in a blast drying oven at 60° C. for 50 minutes to obtain the degreased and impurity-removed gardenia dry powder.

As a preferred embodiment, the pigment adsorption resin comprises the following raw materials in parts by weight:
Polyvinyl alcohol: 10-20 parts;
Maleic rosin acid ethylene glycol acrylate: 20-60 parts;
Initiator: 1-10 parts;
Pore-forming agent: 1-5 parts;
Surfactant: 1-15 parts;
Deionized water: 100-120 parts;
Hexamethylphosphoramide: 10-15 parts.

Wherein the initiator is azobisisobutyronitrile, the surfactant is sodium dodecylbenzenesulfonate, and the pore-forming agent is a 1:1 mixture of polyvinylpyrrolidone and toluene;
The method for preparing the pigment adsorption resin specifically includes:

Take maleic rosin acid ethylene glycol acrylate, polyvinyl alcohol, and initiator, and place them in a beaker as the oil phase;
Place deionized water, hexamethylphosphoramide, and surfactant in a three-necked flask as the water phase. Then mix and stir the oil phase and water phase under nitrogen protection at a stirring speed of 200-250 r/min, and heat in an air bath to 85-90° C. for 2 hours;
Add the pore-forming agent to the three-necked flask and continue reacting for 1 hour. Then adjust the pH of the reaction mixture to 6.0-6.5 with 0.5 mol/L malic acid, cool to room temperature, and add 3 times the volume of anhydrous ethanol to the three-necked flask for extraction for 2 hours to remove residual initiators and pore-forming agents. Finally, use rotary evaporation to obtain the rosin-based pigment adsorption resin.

As a preferred embodiment, the method for loading the crude pigment extract onto the column for adsorption, eluting with a 45% ethanol solution, and separating the pigment solution and impurity solution specifically includes:
Take the pigment adsorption resin, add equal volumes of oxalyl chloride and anhydrous ethanol to the pigment adsorption resin, and mechanically stir at 100-120 r/min for 30 minutes. Under an argon atmosphere, add anhydrous aluminum chloride and react at room temperature for 4 hours;
Add equal volumes of ethanol to wash and filter 3-5 times, then add an equal volume of ethanol to soak overnight. Afterward, dry for 30 minutes. Place the pigment adsorption resin into a three-necked flask, add 4 times the weight of dichloroethane, and stir the mixture. Slowly add 90% concentrated sulfuric acid until the pH reaches 4.5-5;
Heat the three-necked flask in a water bath to 80° C. and react for 4 hours. After the reaction, transfer the pigment adsorption resin from the three-necked flask into a chromatography column and perform reverse washing with ultrapure water 3-5 times until neutral.

As a preferred embodiment, the method for loading the crude pigment extract onto the column for adsorption, eluting with a 45% ethanol solution, and separating the pigment solution and impurity solution further includes:

Wet packing the pigment adsorption resin onto the column, then loading the crude pigment extract onto the column for adsorption for 6 hours. The sample flow rate of the crude pigment extract is 5 ml/min, and the weight ratio of the crude pigment extract to the pigment adsorption resin is 5:2. Elute with a 45% ethanol solution to separate the pigment solution and impurity solution.

As a preferred embodiment, when extracting and purifying chlorogenic acid from the impurity solution, the purification extracting agent is a mixture of acetone and cocoamidopropyl betaine in a 5:1 weight ratio; The stripping agent is a mixture of ethanol and malic acid in a 4:1 volume ratio.

Compared with the prior art, the embodiments of the present application have the following beneficial effects:
The present invention provides a preparation method for high-purity gardenia yellow pigment. By employing techniques such as degreasing and impurity removal of gardenia dry powder and using pigment adsorption resin for adsorption and purification of the crude pigment extract, high-purity and high-color-value gardenia yellow pigment is obtained. Additionally, the method allows for the separation of gardenia glycoside and chlorogenic acid from gardenia yellow pigment, significantly reducing the issues of green discoloration and darkening of color caused by gardenia polysaccharides, gardenia glycosides, and chlorogenic acid.

The embodiments of the present invention provide a pigment adsorption resin and its preparation method. The prepared pigment adsorption resin uses maleic rosin acid ethylene glycol acrylate as the main component, synthesized under conditions that combine surfactants, pore-forming agents, and initiators. This resin can effectively adsorb gardenia yellow pigment and assist in improving its color value. Additionally, it can separate other impurities such as gardenia glycoside and chlorogenic acid, thus enhancing the purity of the product.

In the embodiments of the present invention, sodium dodecyl sulfate and phenol are used to deglycosylate the pre-degreased dry powder, which helps avoid the issue of increased viscosity in gardenia yellow pigment caused by gardenia polysaccharides. This prevents the encapsulation of gardenia yellow pigment, which would otherwise suppress its activity. Furthermore, sodium dodecyl sulfate and phenol can extract gardenia polysaccharides into the organic phase, thus preventing gardenia polysaccharides from interfering with the pigment and purity of gardenia yellow pigment.

### DESCRIPTION OF THE DRAWING

FIG. 1 is a schematic diagram of the implementation process of the high-purity gardenia yellow pigment preparation method provided by the present invention.

FIG. 2 is a schematic diagram of the implementation process of the degreasing and impurity removal treatment of gardenia dry powder provided by the present invention.

FIG. 3 is a schematic diagram of the implementation process of the pre-formulated pigment carrier provided by the present invention.

FIG. 4 is a schematic diagram of the implementation process of the method for extracting crude gardenia dry powder based on supercritical fluid extraction combined with the pre-formulated pigment carrier provided by the present invention.

FIG. 5 is a schematic diagram of the implementation process of loading the crude pigment extract onto the column for adsorption, eluting with a 45% ethanol solution, and separating the pigment solution and impurity solution provided by the present invention.

FIG. 6 is a schematic diagram of the implementation process of preparing the pigment adsorption resin provided by the present invention.

FIG. 7 is a schematic diagram of the sugar yield test results for gardenia polysaccharides in the present invention.

FIG. 8 is a schematic diagram of the adsorption and elution rate test results for porous resins in the present invention.

FIG. 9 is a schematic diagram of the OD value test results in the present invention.

### DETAILED DESCRIPTION OF EMBODIMENTS

Unless otherwise defined, all technical and scientific terms used herein have the meanings commonly understood by those skilled in the art to which this application pertains. The terms used in the description of the application are intended solely for describing specific embodiments and are not meant to limit the scope of this application. The terms “comprising” and “having” and their variations used in the description and claims of this application, as well as in the above figure descriptions, are intended to cover non-exclusive inclusions. The terms “first,” “second,” and the like in the description, claims, or the above figures are used to distinguish different objects and are not intended to describe a specific order.

### Example 1

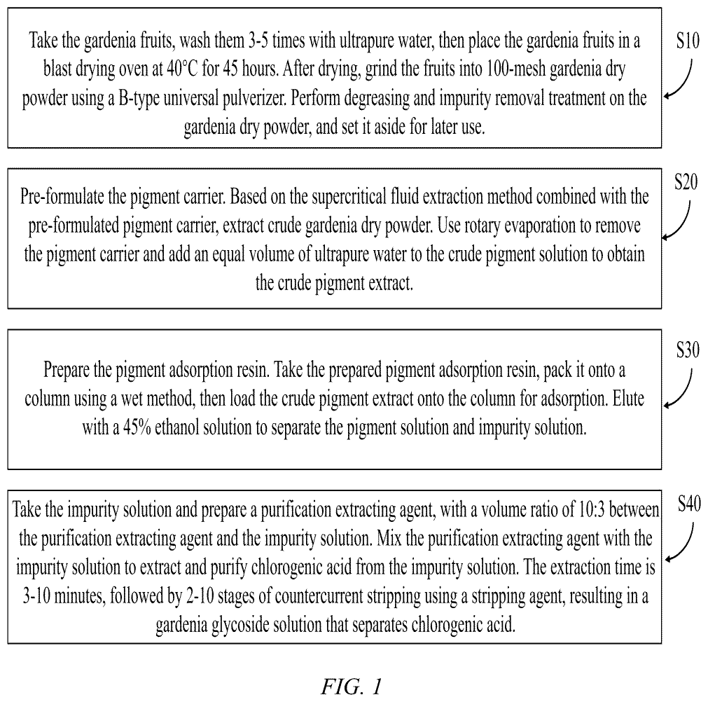

The embodiment of the present invention provides a method for preparing high-purity gardenia yellow pigment. FIG. 1 shows a schematic diagram of the implementation process for preparing the high-purity gardenia yellow pigment. The preparation method specifically includes the following steps:

Step S10: Take gardenia fruits, wash the gardenia fruits 3-5 times using ultrapure water, then place the gardenia fruits in a blast drying oven at 40° C. for 45 hours. After drying, grind the fruits into 100-mesh gardenia dry powder using a B-type universal pulverizer. Perform degreasing and impurity removal treatment on the gardenia dry powder, and set aside for later use;
In this embodiment, the gardenia fruits can be water gardenia produced in Fuzhou, Jiangxi. The B-type universal pulverizer is manufactured by Baokang Drying Machinery Co., Ltd. in Changzhou, China, and the blast drying oven is manufactured by Mettler-Toledo.

Step S20: Pre-formulate the pigment carrier. Based on the supercritical fluid extraction method combined with the pre-formulated pigment carrier, perform the extraction of crude gardenia dry powder. Use rotary evaporation to remove the pigment carrier, and add an equal volume of ultrapure water to the crude pigment solution to obtain the crude pigment extract;
Step S30: Prepare the pigment adsorption resin. Take the prepared pigment adsorption resin, pack it onto a column using a wet method, then load the crude pigment extract onto the column for adsorption. Elute with a 45% ethanol solution to separate the pigment solution and impurity solution;
Step S40: Take the impurity solution, prepare a purification extracting agent, and mix the purification extracting agent with the impurity solution at a volume ratio of 10:3. Mix the purification extracting agent with the impurity solution to extract and purify chlorogenic acid from the impurity solution. The extraction time is 3-10 minutes, followed by 2-10 stages of countercurrent stripping using a stripping agent, resulting in a gardenia glycoside solution that separates chlorogenic acid.

In the extraction and purification of chlorogenic acid from the impurity solution, the purification extracting agent is a mixture of acetone and cocoamidopropyl betaine in a 5:1 weight ratio. During the extraction, the initial pH of the purification extracting agent and impurity solution is 6.5, and the pH of the water phase/organic phase can be adjusted using malic acid. The stripping agent is a mixture of ethanol and malic acid in a 4:1 volume ratio.

It should be noted that in the stripping agent, ethanol is 75% anhydrous ethanol, and malic acid is 0.5 mol/L.

It should also be noted that the pigment adsorption resin includes the following raw materials in parts by weight: polyvinyl alcohol: 10-20 parts; maleic rosin acid ethylene glycol acrylate: 20 parts; initiator: 1 part; pore-forming agent: 1 part; surfactant: 1 part; deionized water: 100 parts; hexamethylphosphoramide: 10 parts;
In this embodiment, polyvinyl alcohol, surfactant, and hexamethylphosphoramide are produced by China National Pharmaceutical Group Chemical Reagents Co., Ltd., and maleic rosin acid ethylene glycol acrylate is produced by Wuzhou Richeng Linchan Chemical Co., Ltd. The deionized water is self-prepared in the laboratory.

In this embodiment, the initiator is azobisisobutyronitrile, the surfactant is sodium dodecylbenzenesulfonate, and the pore-forming agent is a 1:1 mixture of polyvinylpyrrolidone and toluene.

In the present invention, polyvinylpyrrolidone and toluene work synergistically, significantly increasing the specific surface area of the pigment adsorption resin. This, in turn, enhances the pore density of the pigment adsorption resin, ensuring uniform pore size and improving the stability of the resin in adsorbing gardenia yellow pigment.

The method for preparing the pigment adsorption resin specifically includes the following steps:
Step S401: Take maleic rosin acid ethylene glycol acrylate, polyvinyl alcohol, and initiator, and place them in a beaker as the oil phase;
Step S402: Place deionized water, hexamethylphosphoramide, and surfactant in a three-necked flask as the water phase. Then, mix and stir the oil phase and water phase under nitrogen protection at a stirring speed of 200-250 r/min. Heat the mixture in an air bath to 85-90° C. for 2 hours;
Step S403: Add the pore-forming agent to the three-necked flask and continue the reaction for 1 hour. Then, adjust the pH to 6.0-6.5 using 0.5 mol/L malic acid. Cool to room temperature, then add 3 times the volume of anhydrous ethanol to the three-necked flask and extract for 2 hours to remove residual initiators and pore-forming agents. Use rotary evaporation to obtain the rosin-based pigment adsorption resin;
The embodiment of the present invention provides the pigment adsorption resin and its preparation method. The prepared pigment adsorption resin uses maleic rosin acid ethylene glycol acrylate as the main component, synthesized under conditions combining surfactants, pore-forming agents, and initiators. This resin can effectively adsorb gardenia yellow pigment, assist in improving the color value of gardenia yellow pigment, and separate other impurities, such as gardenia glycoside and chlorogenic acid, thereby enhancing the purity of the product.

The method for preparing high-purity gardenia yellow pigment provided by the present invention uses gardenia dry powder degreasing and impurity removal treatment, along with the adsorption and purification of the crude pigment extract using pigment adsorption resin. This results in high-purity and high-color-value gardenia yellow pigment. Additionally, it allows for the separation of gardenia glycoside and chlorogenic acid from the gardenia yellow pigment, significantly reducing the issues of green discoloration and darkening caused by gardenia polysaccharides, gardenia glycosides, and chlorogenic acid.

### Example 2

The embodiment of the present invention provides a method for preparing high-purity gardenia yellow pigment. FIG. 1 shows a schematic diagram of the implementation process for preparing the high-purity gardenia yellow pigment. The method specifically includes the following steps:
Step S10: Take gardenia fruits, wash them 3-5 times with ultrapure water, then place the gardenia fruits in a blast drying oven at 40° C. for 45 hours. After drying, grind the fruits into 100-mesh gardenia dry powder using a B-type universal pulverizer. Perform degreasing and impurity removal treatment on the gardenia dry powder, and set aside for later use;
Step S20: Pre-formulate the pigment carrier. Based on the supercritical fluid extraction method combined with the pre-formulated pigment carrier, extract crude gardenia dry powder. Use rotary evaporation to remove the pigment carrier and add an equal volume of ultrapure water to the crude pigment solution to obtain the crude pigment extract;
Step S30: Prepare the pigment adsorption resin. Take the prepared pigment adsorption resin, pack it onto a column using a wet method, then load the crude pigment extract onto the column for adsorption. Elute with a 45% ethanol solution to separate the pigment solution and impurity solution;
Step S40: Take the impurity solution, prepare a purification extracting agent, and mix the purification extracting agent with the impurity solution at a volume ratio of 10:3. Mix the purification extracting agent with the impurity solution to extract and purify chlorogenic acid from the impurity solution. The extraction time is 3-10 minutes, followed by 2-10 stages of countercurrent stripping using a stripping agent, resulting in a gardenia glycoside solution that separates chlorogenic acid.

In the extraction and purification of chlorogenic acid from the impurity solution, the purification extracting agent is a mixture of acetone and cocoamidopropyl betaine in a 5:1 weight ratio. The stripping agent is a mixture of ethanol and malic acid in a 4:1 volume ratio.

It should be noted that the pigment adsorption resin includes the following raw materials in parts by weight: polyvinyl alcohol: 10-20 parts; maleic rosin acid ethylene glycol acrylate: 60 parts; initiator: 10 parts; pore-forming agent: 5 parts; surfactant: 15 parts; deionized water: 120 parts; hexamethylphosphoramide: 15 parts.

Wherein the initiator is azobisisobutyronitrile, the surfactant is sodium dodecylbenzenesulfonate, and the pore-forming agent is a 1:1 mixture of polyvinylpyrrolidone and toluene.

The method for preparing the pigment adsorption resin specifically includes:
Step S401: Take maleic rosin acid ethylene glycol acrylate, polyvinyl alcohol, and initiator, and place them in a beaker as the oil phase.
Step S402: Place deionized water, hexamethylphosphoramide, and surfactant in a three-necked flask as the water phase. Then, mix and stir the oil phase and water phase under nitrogen protection at a stirring speed of 200-250 r/min. Heat the mixture in an air bath to 85-90° C. for 2 hours.
Step S403: Add the pore-forming agent to the three-necked flask and continue the reaction for 1 hour. Then, adjust the pH to 6.0-6.5 using 0.5 mol/L malic acid. Cool to room temperature, then add 3 times the volume of anhydrous ethanol to the three-necked flask and extract for 2 hours to remove residual initiators and pore-forming agents. Finally, use rotary evaporation to obtain the rosin-based pigment adsorption resin.

### Example 3

The embodiment of the present invention provides a method for preparing high-purity gardenia yellow pigment. FIG. 1 shows a schematic diagram of the implementation process for preparing the high-purity gardenia yellow pigment. The preparation method specifically includes the following steps:
Step S10: Take gardenia fruits, wash the gardenia fruits 3-5 times with ultrapure water, then place the gardenia fruits in a blast drying oven at 40° C. for 45 hours. After drying, grind the fruits into 100-mesh gardenia dry powder using a B-type universal pulverizer. Perform degreasing and impurity removal treatment on the gardenia dry powder, and set aside for later use;
Step S20: Pre-formulate the pigment carrier. Based on the supercritical fluid extraction method combined with the pre-formulated pigment carrier, extract crude gardenia dry powder. Use rotary evaporation to remove the pigment carrier and add an equal volume of ultrapure water to the crude pigment solution to obtain the crude pigment extract;
Step S30: Prepare the pigment adsorption resin. Take the prepared pigment adsorption resin, pack it onto a column using a wet method, then load the crude pigment extract onto the column for adsorption. Elute with a 45% ethanol solution to separate the pigment solution and impurity solution.
Step S40: Take the impurity solution, prepare a purification extracting agent, and mix the purification extracting agent with the impurity solution at a volume ratio of 10:3. Mix the purification extracting agent with the impurity solution to extract and purify chlorogenic acid from the impurity solution. The extraction time is 3-10 minutes, followed by 2-10 stages of countercurrent stripping using a stripping agent, resulting in a gardenia glycoside solution that separates chlorogenic acid.

In the extraction and purification of chlorogenic acid from the impurity solution, the purification extracting agent is a mixture of acetone and cocoamidopropyl betaine in a 5:1 weight ratio; the stripping agent is a mixture of ethanol and malic acid in a 4:1 volume ratio.

It should be noted that the pigment adsorption resin includes the following raw materials in parts by weight: polyvinyl alcohol: 10-20 parts; maleic rosin acid ethylene glycol acrylate: 25 parts; initiator: 2 parts; pore-forming agent: 2 parts; surfactant: 3 parts; deionized water: 102 parts; hexamethylphosphoramide: 11 parts.

Wherein the initiator is azobisisobutyronitrile, the surfactant is sodium dodecylbenzenesulfonate, and the pore-forming agent is a 1:1 mixture of polyvinylpyrrolidone and toluene.

The method for preparing the pigment adsorption resin specifically includes:
Step S401: Take maleic rosin acid ethylene glycol acrylate, polyvinyl alcohol, and initiator, and place them in a beaker as the oil phase;
Step S402: Place deionized water, hexamethylphosphoramide, and surfactant in a three-necked flask as the water phase. Then, mix and stir the oil phase and water phase under nitrogen protection at a stirring speed of 200-250 r/min. Heat the mixture in an air bath to 85-90° C. for 2 hours;
Step S403: Add the pore-forming agent to the three-necked flask and continue the reaction for 1 hour. Then, adjust the pH to 6.0-6.5 using 0.5 mol/L malic acid. Cool to room temperature, then add 3 times the volume of anhydrous ethanol to the three-necked flask and extract for 2 hours to remove residual initiators and pore-forming agents. Finally, use rotary evaporation to obtain the rosin-based pigment adsorption resin.

### Example 4

The embodiment of the present invention provides a method for preparing high-purity gardenia yellow pigment. FIG. 1 shows a schematic diagram of the implementation process for preparing the high-purity gardenia yellow pigment. The preparation method specifically includes the following steps:
Step S10: Take gardenia fruits, wash them 3-5 times with ultrapure water, then place the gardenia fruits in a blast drying oven at 40° C. for 45 hours. After drying, grind the fruits into 100-mesh gardenia dry powder using a B-type universal pulverizer. Perform degreasing and impurity removal treatment on the gardenia dry powder, and set aside for later use;
Step S20: Pre-formulate the pigment carrier. Based on the supercritical fluid extraction method combined with the pre-formulated pigment carrier, extract crude gardenia dry powder. Use rotary evaporation to remove the pigment carrier and add an equal volume of ultrapure water to the crude pigment solution to obtain the crude pigment extract;
Step S30: Prepare the pigment adsorption resin. Take the prepared pigment adsorption resin, pack it onto a column using a wet method, then load the crude pigment extract onto the column for adsorption. Elute with a 45% ethanol solution to separate the pigment solution and impurity solution;
Step S40: Take the impurity solution, prepare a purification extracting agent, and mix the purification extracting agent with the impurity solution at a volume ratio of 10:3. Mix the purification extracting agent with the impurity solution to extract and purify chlorogenic acid from the impurity solution. The extraction time is 3-10 minutes, followed by 2-10 stages of countercurrent stripping using a stripping agent, resulting in a gardenia glycoside solution that separates chlorogenic acid.

In the extraction and purification of chlorogenic acid from the impurity solution, the purification extracting agent is a mixture of acetone and cocoamidopropyl betaine in a 5:1 weight ratio; the stripping agent is a mixture of ethanol and malic acid in a 4:1 volume ratio.

It should be noted that the pigment adsorption resin includes the following raw materials in parts by weight: polyvinyl alcohol: 19 parts; maleic rosin acid ethylene glycol acrylate: 58 parts; initiator: 9 parts; pore-forming agent: 4 parts; surfactant: 12 parts; deionized water: 115 parts; hexamethylphosphoramide: 14 parts.

Wherein the initiator is azobisisobutyronitrile, the surfactant is sodium dodecylbenzenesulfonate, and the pore-forming agent is a 1:1 mixture of polyvinylpyrrolidone and toluene.

The method for preparing the pigment adsorption resin specifically includes:
Step S401: Take maleic rosin acid ethylene glycol acrylate, polyvinyl alcohol, and initiator, and place them in a beaker as the oil phase;
Step S402: Place deionized water, hexamethylphosphoramide, and surfactant in a three-necked flask as the water phase. Then, mix and stir the oil phase and water phase under nitrogen protection at a stirring speed of 200-250 r/min. Heat the mixture in an air bath to 85-90° C. for 2 hours;
Step S403: Add the pore-forming agent to the three-necked flask and continue the reaction for 1 hour. Then, adjust the pH to 6.0-6.5 using 0.5 mol/L malic acid. Cool to room temperature, then add 3 times the volume of anhydrous ethanol to the three-necked flask and extract for 2 hours to remove residual initiators and pore-forming agents. Finally, use rotary evaporation to obtain the rosin-based pigment adsorption resin.

### Example 5

The embodiment of the present invention provides a method for preparing high-purity gardenia yellow pigment. FIG. 1 shows a schematic diagram of the implementation process for preparing the high-purity gardenia yellow pigment. The preparation method specifically includes the following steps:
Step S10: Take gardenia fruits, wash them 3-5 times with ultrapure water, then place the gardenia fruits in a blast drying oven at 40° C. for 45 hours. After drying, grind the fruits into 100-mesh gardenia dry powder using a B-type universal pulverizer. Perform degreasing and impurity removal treatment on the gardenia dry powder, and set aside for later use;
Step S20: Pre-formulate the pigment carrier. Based on the supercritical fluid extraction method combined with the pre-formulated pigment carrier, extract crude gardenia dry powder. Use rotary evaporation to remove the pigment carrier and add an equal volume of ultrapure water to the crude pigment solution to obtain the crude pigment extract;
Step S30: Prepare the pigment adsorption resin. Take the prepared pigment adsorption resin, pack it onto a column using a wet method, then load the crude pigment extract onto the column for adsorption. Elute with a 45% ethanol solution to separate the pigment solution and impurity solution;
Step S40: Take the impurity solution, prepare a purification extracting agent, and mix the purification extracting agent with the impurity solution at a volume ratio of 10:3. Mix the purification extracting agent with the impurity solution to extract and purify chlorogenic acid from the impurity solution. The extraction time is 3-10 minutes, followed by 2-10 stages of countercurrent stripping using a stripping agent, resulting in a gardenia glycoside solution that separates chlorogenic acid.

In the extraction and purification of chlorogenic acid from the impurity solution, the purification extracting agent is a mixture of acetone and cocoamidopropyl betaine in a 5:1 weight ratio. The stripping agent is a mixture of ethanol and malic acid in a 4:1 volume ratio.

It should be noted that the pigment adsorption resin includes the following raw materials in parts by weight: polyvinyl alcohol: 15 parts; maleic rosin acid ethylene glycol acrylate: 40 parts; initiator: 5 parts; pore-forming agent: 3 parts; surfactant: 9 parts; deionized water: 112 parts; hexamethylphosphoramide: 12 parts.

Wherein the initiator is azobisisobutyronitrile, the surfactant is sodium dodecylbenzenesulfonate, and the pore-forming agent is a 1:1 mixture of polyvinylpyrrolidone and toluene.

The method for preparing the pigment adsorption resin specifically includes:
Step S401: Take maleic rosin acid ethylene glycol acrylate, polyvinyl alcohol, and initiator, and place them in a beaker as the oil phase;
Step S402: Place deionized water, hexamethylphosphoramide, and surfactant in a three-necked flask as the water phase. Then, mix and stir the oil phase and water phase under nitrogen protection at a stirring speed of 200-250 r/min. Heat the mixture in an air bath to 85-90° C. for 2 hours;
Step S403: Add the pore-forming agent to the three-necked flask and continue the reaction for 1 hour. Then, adjust the pH to 6.0-6.5 using 0.5 mol/L malic acid. Cool to room temperature, then add 3 times the volume of anhydrous ethanol to the three-necked flask and extract for 2 hours to remove residual initiators and pore-forming agents. Finally, use rotary evaporation to obtain the rosin-based pigment adsorption resin.

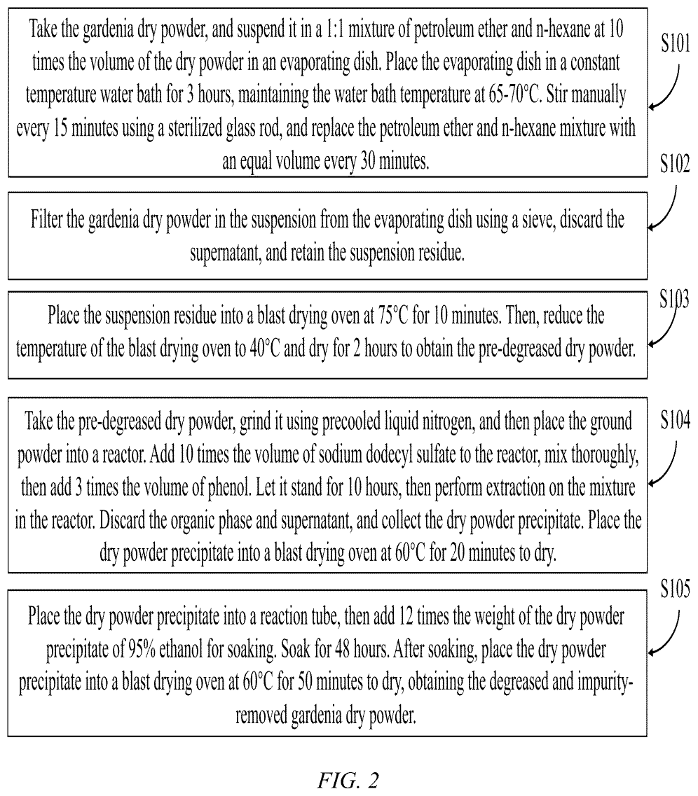

In the embodiment of the present invention, as shown in FIG. 2, the method for degreasing and impurity removal of gardenia dry powder specifically includes the following steps:
Step S101: Take gardenia dry powder, mix it with a 1:1 mixture of petroleum ether and n-hexane at 10 times the volume of the dry powder in an evaporating dish. Suspend the mixture and place the evaporating dish in a constant temperature water bath for 3 hours, maintaining the temperature of the water bath at 65-70° C. Stir manually every 15 minutes using a sterilized glass rod, and replace the petroleum ether and n-hexane mixture with an equal volume every 30 minutes.

It should be noted that the petroleum ether and n-hexane are supplied by Shandong Aite Chemical Co., Ltd., and the constant temperature water bath is manufactured by Shanghai Boxinda Industrial Co., Ltd. (SHA-C model).

In Step S101, the synergistic use of petroleum ether and n-hexane mixed solution effectively degreases the gardenia dry powder, preventing the interference of low-chain and long-chain alkane molecules in the purification and separation of gardenia yellow pigment. Furthermore, the degreasing efficiency of petroleum ether and n-hexane is high, cost-effective, easy to operate, environmentally friendly, and helps improve the product quality;
Step S102: Filter the gardenia dry powder from the suspension in the evaporating dish using a sieve, discard the supernatant, and retain the residue;
Step S103: Place the residue into a blast drying oven at 75° C. for 10 minutes. Then, lower the temperature of the blast drying oven to 40° C. and dry for 2 hours to obtain the pre-degreased dry powder;
Step S104: Take the pre-degreased dry powder, grind it using precooled liquid nitrogen. After grinding, place the powder into a reactor. Add 10 times the volume of sodium dodecyl sulfate to the reactor, mix thoroughly, then add 3 times the volume of phenol. Let it stand for 10 hours, then perform extraction on the mixture in the reactor. Discard the organic phase and supernatant, collect the dry powder precipitate, and dry the precipitate in a blast drying oven at 60° C. for 20 minutes.

It should be noted that in the embodiment of the present invention, sodium dodecyl sulfate and phenol are used to perform a deglycosylation treatment on the pre-degreased dry powder. This treatment helps avoid the increase in viscosity of gardenia yellow pigment caused by the presence of gardenia polysaccharides, which can otherwise wrap the pigment and inhibit its activity. Additionally, sodium dodecyl sulfate and phenol can extract gardenia polysaccharides into the organic phase, preventing the polysaccharides from interfering with the pigment and purity of gardenia yellow pigment. This overcomes the issues with existing methods that involve solvent crystallization, which are time-consuming, yield low amounts, and cannot separate impurities such as gardenia polysaccharides, thereby affecting the purity of gardenia yellow pigment.

Step S105: Place the dry powder precipitate into a reaction tube, then add 12 times the weight of the dry powder precipitate of 95% ethanol for soaking. Soak for 48 hours, and after soaking, place the dry powder precipitate into a blast drying oven at 60° C. for 50 minutes to obtain the degreased and impurity-removed gardenia dry powder.

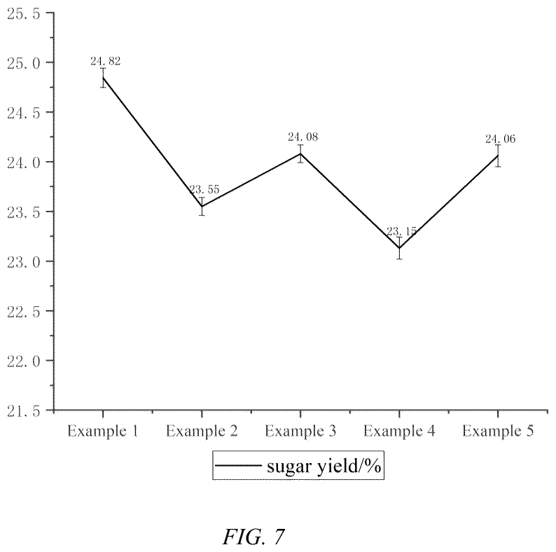

The organic phase obtained in Step S104 of the gardenia dry powder degreasing and impurity removal process from Examples 1-5 is analyzed using a liquid chromatograph to determine the composition of gardenia polysaccharides in the organic phase. The gardenia polysaccharides contain rhamnose, arabinose, mannose, glucose, and galactose. The sugar yield of gardenia polysaccharides in the organic phase from Examples 1-5 is determined using a colorimetric method combined with a UV-Vis spectrophotometer. The test results are shown in FIG. 7 and Table 1.

TABLE 1

| Sample | Example 1 | Example 2 | Example 3 | Example 4 | Example 5 |
|---|---|---|---|---|---|
| Sugar | 24.82 | 23.55 | 24.08 | 23.15 | 24.06 |
| Yield/% | | | | | |

From Table 1, it can be seen that in Embodiments 1-5 of the present invention, the degreasing and impurity removal treatment of gardenia dry powder effectively recovers gardenia polysaccharides from the pre-degreased dry powder, ensuring the purity and color of the gardenia yellow pigment.

It should be noted that in this embodiment, the pigment carrier includes the following raw materials in weight percentage:
ethanol: 65%;
acetone: 10%;
ether: 15%;
ethyl acetate: 10%.

In the embodiments of the present invention, the pigment carrier is formed by mixing ethanol, ether, acetone, and ethyl acetate. Compared to ethanol in the prior art, the pigment carrier has advantages such as faster extraction speed, higher efficiency, and simpler operation. Additionally, it ensures that there is no organic solvent residue in the product, and the extracted active ingredients maintain maximum biological activity.

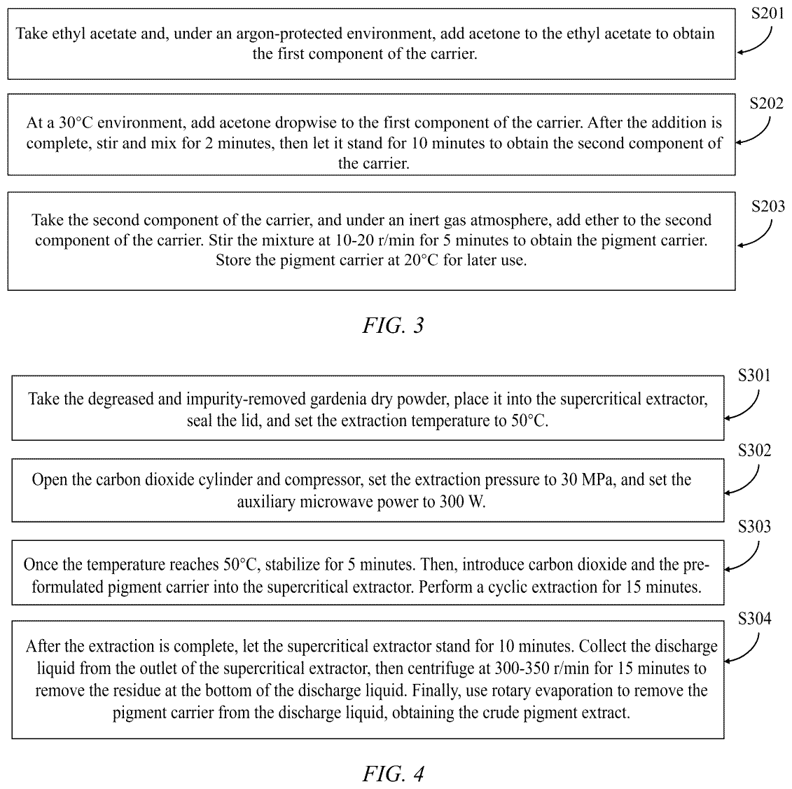

As shown in FIG. 3, the method for pre-formulating the pigment carrier specifically includes the following steps:
Step S201: Take ethyl acetate, and under an argon-protected environment, add acetone to the ethyl acetate to obtain the first component of the carrier;
Step S202: At a 30° C. environment, add acetone dropwise to the first component of the carrier. After the addition is complete, stir and mix for 2 minutes, then let it stand for 10 minutes to obtain the second component of the carrier;
Step S203: Take the second component of the carrier, and under an inert gas environment, add ether to the second component of the carrier. Stir at 10-20 r/min for 5 minutes to obtain the pigment carrier, then store the pigment carrier at 20° C. for later use.

As shown in FIG. 4, the method for extracting crude gardenia dry powder based on supercritical fluid extraction combined with the pre-formulated pigment carrier specifically includes the following steps:
Step S301: Take the degreased and impurity-removed gardenia dry powder, place the gardenia dry powder into the supercritical extractor, seal the lid, and set the extraction temperature to 50° C.;
Step S302: Open the carbon dioxide cylinder and compressor, set the extraction pressure to 30 MPa, and set the auxiliary microwave power to 300 W;
Step S303: After the temperature reaches 50° C., stabilize for 5 minutes, then introduce carbon dioxide and the pre-formulated pigment carrier into the supercritical extractor. Perform a cyclic extraction for 15 minutes, where the carbon dioxide flow rate is set to 3-3.5 L/min and the pigment carrier flow rate is set to 0.4-0.5 mL/min;
Step S304: After the extraction is completed, let the supercritical extractor stand for 10 minutes, collect the discharge liquid from the outlet of the supercritical extractor, and centrifuge at 300-350 r/min for 15 minutes to remove the residue at the bottom of the discharge liquid. Then, use rotary evaporation to remove the pigment carrier from the discharge liquid to obtain the crude pigment extract.

In this embodiment, the supercritical extractor is the SFE-4 supercritical CO₂ extractor, and the centrifugation is performed using a Microfuge 16 microcentrifuge at 300-350 r/min.

In this embodiment of the present invention, the method combines supercritical fluid extraction with the pre-formulated pigment carrier for extracting crude gardenia dry powder. The use of auxiliary microwaves in the extraction process increases the frequency and speed of gardenia yellow pigment molecule movement, enhances the penetration ability of the pigment carrier, and ensures the activity of the gardenia yellow pigment, making it suitable for the rapid extraction of natural yellow pigments.

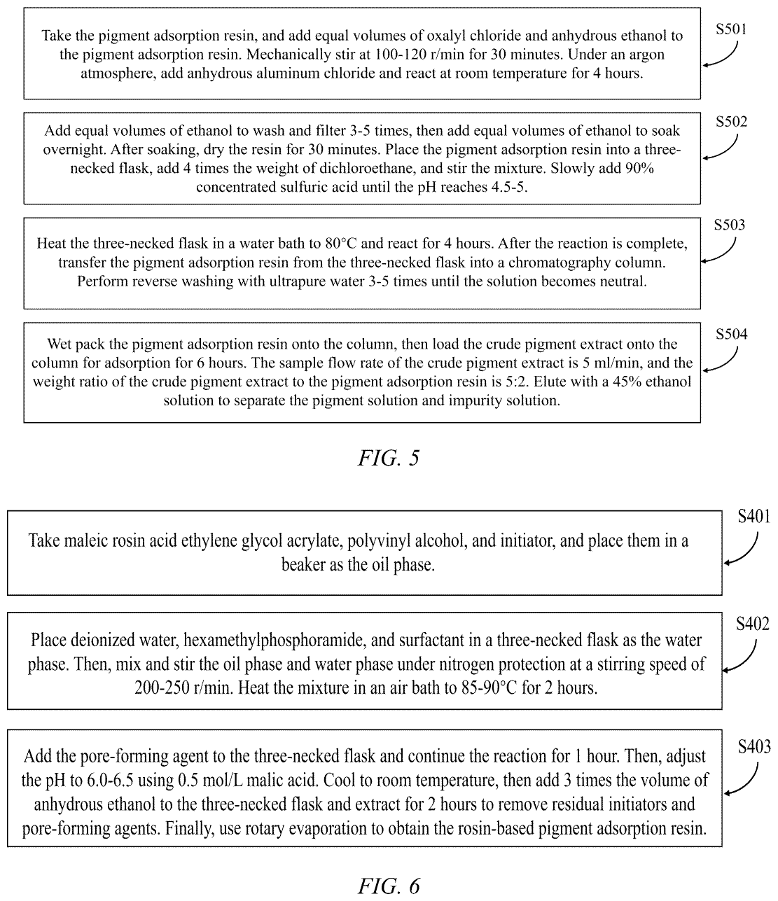

In the embodiment of the present invention, as shown in FIG. 5, the method for loading the crude pigment extract onto the column for adsorption, eluting with a 45% ethanol solution, and separating the pigment solution and impurity solution specifically includes the following steps:
Step S501: Take the pigment adsorption resin, add equal volumes of oxalyl chloride and anhydrous ethanol to the pigment adsorption resin, and mechanically stir at 100-120 r/min for 30 minutes. Under an argon atmosphere, add anhydrous aluminum chloride and react at room temperature for 4 hours;
In this embodiment, in Step S501, the combination of oxalyl chloride and anhydrous ethanol with the catalyst anhydrous aluminum chloride allows the introduction of methylene chloride groups into the pigment adsorption resin, enhancing the resin's affinity for the functional groups of gardenia yellow pigment, improving the resin's adsorption capacity, and reducing non-specific adsorption of other molecules in the crude pigment extract;
Step S502: Add equal volumes of ethanol to wash and filter 3-5 times, then add equal volumes of ethanol to soak overnight. After soaking, dry the resin for 30 minutes. Place the pigment adsorption resin into a three-necked flask, add 4 times the weight of dichloroethane, and stir the mixture. Slowly add 90% concentrated sulfuric acid until the pH reaches 4.5-5;
Step S503: Heat the three-necked flask in a water bath to 80° C. and react for 4 hours. After the reaction is complete, transfer the pigment adsorption resin from the three-necked flask into a chromatography column and perform reverse washing with ultrapure water 3-5 times until neutral;
Step S504: Wet pack the pigment adsorption resin onto the column, then load the crude pigment extract onto the column for adsorption for 6 hours. The sample flow rate of the crude pigment extract is 5 ml/min, and the weight ratio of the crude pigment extract to the pigment adsorption resin is 5:2. Elute with a 45% ethanol solution to separate the pigment solution and impurity solution.

It should be noted that when eluting with a 45% ethanol solution, the elution flow rate is set to 4 ml/min. The separated pigment solution is then concentrated by rotary evaporation under reduced pressure to one-eighth of its original volume. The concentrated solution is placed in a −60° C. freezer for 24 hours, followed by vacuum freeze-drying under a pressure of 0.02 mbar to obtain the high-purity yellow pigment powder.

### Comparative Example 1

The steps of this Comparative Example are similar to those in Example 5. The difference in this Comparative Example is that the raw materials for the pigment adsorption resin do not include polyvinyl alcohol and surfactant, while the other raw materials are the same as in Example 5

### Comparative Example 2

The steps of this Comparative Example are similar to those in Example 5. The difference in this Comparative Example is that the raw materials for the pigment adsorption resin do not include polyvinyl alcohol, surfactant, and polyvinylpyrrolidone, while the other raw materials are the same as in Example 5.

### Comparative Example 3

The steps of this Comparative Example are similar to those in Example 5. The difference in this Comparative Example is that the raw materials for the pigment adsorption resin do not include surfactant and polyvinylpyrrolidone, while the other raw materials are the same as in Example 5.

### Comparative Example 4

The steps of this Comparative Example are similar to those in Example 5. The difference in this Comparative Example is that the commercially available porous resin product LSA-10 is used to replace the pigment adsorption resin.

### Comparative Example 5

The steps of this Comparative Example are similar to those in Example 5. The difference in this Comparative Example is that the commercially available porous resin product LX-60 is used to replace the pigment adsorption resin.

### Comparative Example 6

The steps of this Comparative Example are similar to those in Example 5. The difference in this Comparative Example is that the commercially available porous resin product HPD100A is used to replace the pigment adsorption resin.

### Performance Testing:

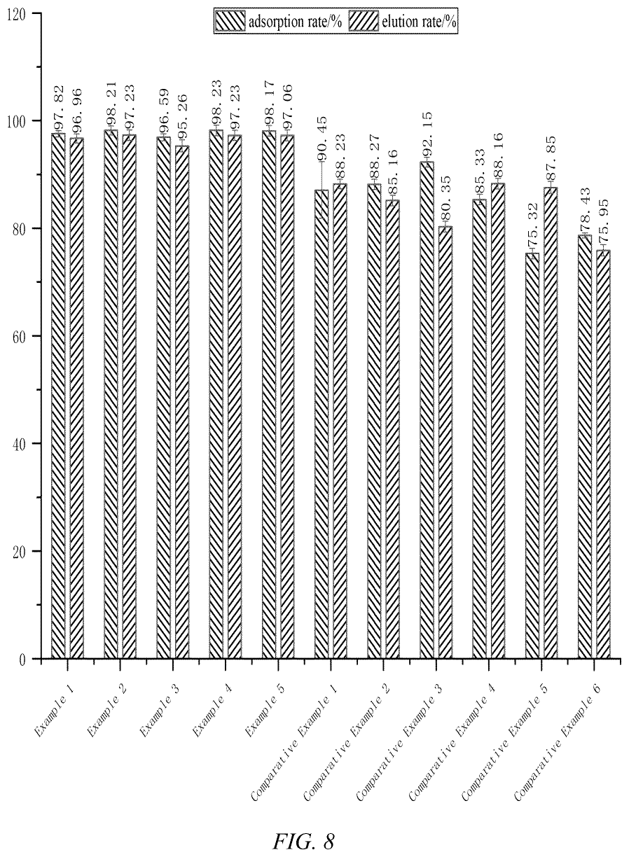

1) The adsorption rate and elution rate of the porous resin are tested for Examples 1-5 and Comparative Examples 1-6, respectively. The A440 nm absorbance of the crude pigment extract solution before and after adsorption and before and after elution is measured based on spectrophotometry. The results of the porous resin adsorption rate and elution rate tests are shown in FIG. 8 and Table 2.

TABLE 2

| Test items | Adsorption rate/% | Elution rate/% |
|---|---|---|
| Example 1 | 97.82 | 96.96 |
| Example 2 | 98.21 | 97.23 |
| Example 3 | 96.59 | 95.26 |
| Example 4 | 98.23 | 97.23 |
| Example 5 | 98.17 | 97.06 |
| Comparative | 90.45 | 88.23 |
| Example 1 | | |
| Comparative | 88.27 | 85.16 |
| Example 2 | | |
| Comparative | 92.15 | 80.35 |
| Example 3 | | |
| Comparative | 85.33 | 88.16 |
| Example 4 | | |
| Comparative | 75.32 | 87.85 |
| Example 5 | | |
| Comparative | 78.43 | 75.95 |
| Example 6 | | |

The data results in Table 2 show that the adsorption rate and elution rate of Examples 1-5 of the present invention are higher than those of the porous resins in Comparative Examples 1-6. The high-purity gardenia yellow pigment preparation method provided by the present invention is capable of extracting high-purity gardenia yellow pigment.

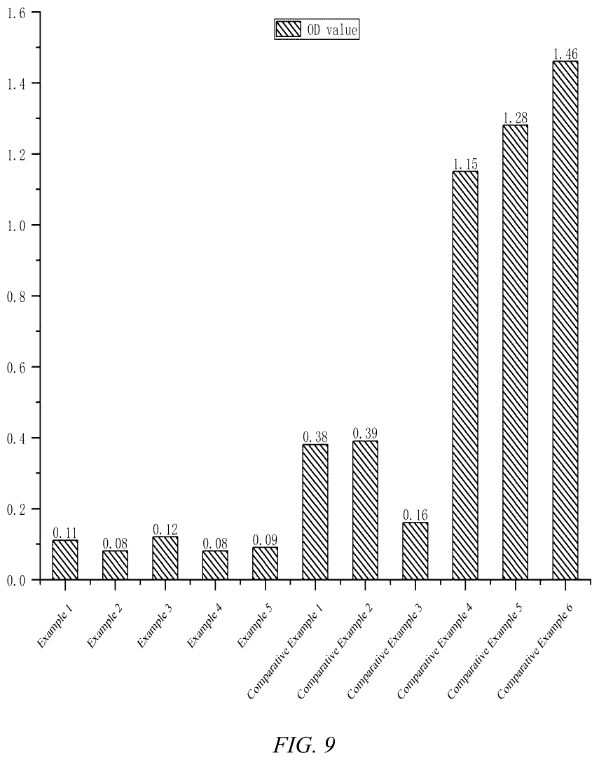

The color value and OD value were tested for Examples 1-5 of the present invention and Comparative Examples 1-6. The OD value test results are shown in FIG. 9, and Table 3 presents the OD value and color value test results.

TABLE 3

| Test items | Color value | OD value |
|---|---|---|
| Example 1 | 400 | 0.11 |
| Example 2 | 404 | 0.08 |
| Example 3 | 393 | 0.12 |
| Example 4 | 405 | 0.08 |
| Example 5 | 402 | 0.09 |
| Comparative | 198 | 0.38 |
| Example 1 | | |
| Comparative | 156 | 0.39 |
| Example 2 | | |
| Comparative | 326 | 0.16 |
| Example 3 | | |
| Comparative | 98 | 1.15 |
| Example 4 | | |
| Comparative | 78 | 1.28 |
| Example 5 | | |
| Comparative | 76 | 1.46 |
| Example 6 | | |

The data results in Table 3 show that Examples 1-5 of the present invention have lower OD values and higher color values compared to Comparative Examples 1-6, indicating that the extracted gardenia yellow pigment has higher purity. The content of impurities such as gardenia glycoside and chlorogenic acid is lower, and their impact on gardenia yellow pigment is minimal. This ensures the quality of the gardenia yellow pigment. Compared to Comparative Examples 1-6, the gardenia yellow pigment extracted in Examples 1-5 of the present invention can effectively prevent green discoloration and darkening of the color.

In summary, the present invention provides a method for preparing high-purity gardenia yellow pigment. This method improves the purity and color value of gardenia yellow pigment by employing degreasing and impurity removal treatment of gardenia dry powder, as well as the use of pigment adsorption resin to adsorb and purify the crude pigment extract. Additionally, the method enables the separation of gardenia glycoside and chlorogenic acid from the gardenia yellow pigment, significantly reducing the issues of green discoloration and darkening of color caused by gardenia polysaccharides, gardenia glycoside, and chlorogenic acid.

It should be noted that the embodiments described above are presented as a sequence of actions for simplicity. However, those skilled in the art should understand that the present invention is not limited by the described order of actions, as some steps may be performed in a different order or simultaneously.

The above embodiments are only intended to illustrate the technical solutions of the present invention and should not be construed as limiting the scope of the invention. Clearly, the described embodiments are only a portion of the embodiments of the present invention and not all possible embodiments. All other embodiments derived by those skilled in the art, without making any inventive effort, based on these embodiments, are also within the scope of protection of the present invention. Although the present invention has been described in detail with reference to the above embodiments, those skilled in the art can still, without making creative efforts, combine, add, or delete features from the embodiments of the present invention in a way that does not conflict, or make other adjustments to obtain different technical solutions that do not deviate from the essential concepts of the present invention. These technical solutions are also within the scope of protection of the present invention.

1. A method for preparing a gardenia yellow pigment, characterized in that the method comprises the following steps:
taking gardenia fruits, washing the gardenia fruits 3-5 times using ultrapure water, then placing the gardenia fruits in a blast drying oven at 40° C. for 45 hours, after drying, grinding the gardenia fruits into 100-mesh gardenia dry powder using a B-type universal pulverizer, performing degrease and impurity removal treatment on the gardenia dry powder, and setting aside;
pre-formulating a pigment carrier, and combining the pre-formulated pigment carrier with the gardenia dry powder using a supercritical fluid extraction to obtain a crude pigment extract, removing the pigment carrier from the crude pigment extract using rotary evaporation, adding an equal volume of ultrapure water to the crude pigment extract to obtain a crude pigment solution; and
preparing a pigment adsorption resin, and loading the prepared pigment adsorption resin onto a column by wet packing, loading the crude pigment extract onto the column for adsorption, and eluting with a 45% ethanol solution to obtain a gardenia yellow pigment solution that contains the gardenia yellow pigment.

2. The method for preparing gardenia yellow pigment as described in claim 1, wherein the pigment carrier comprises the following raw materials in weight percentage:
ethanol: 65%;
acetone: 10%;
ether: 15%;
ethyl acetate: 10%; and
wherein a method for pre-formulating the pigment carrier comprising:
taking ethyl acetate, and under an argon-protected environment, adding acetone to the ethyl acetate to obtain a first component of the pigment carrier;
under a 30° C. environment, adding acetone dropwise to the first component of the pigment carrier, after the addition is complete, stirring and mixing for 2 minutes, then standing for 10 minutes to obtain a second component of the pigment carrier; and
taking the second component of the carrier, and under an inert gas environment, adding ether to the second component of the pigment carrier, stirring at 10-20 r/min for 5 minutes to obtain the pigment carrier, then storing the pigment carrier at 20° C. for later use.

3. The method for preparing gardenia yellow pigment as described in claim 1, wherein a method for extracting the crude gardenia dry powder based on supercritical fluid extraction combined with the pre-formulated pigment carrier comprising:
taking the degreased and impurity-removed gardenia dry powder, placing the gardenia dry powder into the supercritical fluid extractor, sealing a lid of the supercritical fluid extractor, and setting an extraction temperature to 50° C.;
opening a carbon dioxide cylinder and compressor, setting an extraction pressure to 30 MPa, and setting an auxiliary microwave power to 300 W;
after the extraction temperature reaches 50° C., stabilizing for 5 minutes, then introducing carbon dioxide and the pre-formulated pigment carrier into the supercritical fluid extractor, and performing a cyclic extraction for 15 minutes, where a carbon dioxide flow rate is set to 3-3.5 L/min and a pigment carrier flow rate is set to 0.4-0.5 mL/min; and
after the extraction, letting the supercritical fluid extractor stand for 10 minutes, collecting a discharge liquid from an outlet of the supercritical fluid extractor, centrifuging at 300-350 r/min for 15 minutes to remove a residue at a bottom of the discharge liquid, then using rotary evaporation to remove the pigment carrier from the discharge liquid to obtain the crude pigment extract.

4. The method for preparing gardenia yellow pigment as described in claim 1, wherein a method for degreasing and impurity removal treatment of the gardenia dry powder comprises:
taking the gardenia dry powder, mixing with a 1:1 mixture of petroleum ether and n-hexane at 10 times a volume of the dry powder in an evaporating dish, and suspending, placing the evaporating dish in a constant temperature water bath for 3 hours, maintaining a water bath temperature at 65-70° C., stirring manually every 15 minutes, and replacing a same volume of petroleum ether and n-hexane every 30 minutes;
filtering the gardenia dry powder from a suspension in the evaporating dish using a sieve, discard a supernatant, and retain a residue; and
placing the residue into a blast drying oven at 75° C. for 10 minutes, then lowering a temperature of the blast drying oven to 40° C. and drying for 2 hours to obtain the pre-degreased dry powder.

5. The method for preparing gardenia yellow pigment as described in claim 4, wherein a method for degreasing and impurity removal treatment of the gardenia dry powder further comprises:
taking the pre-degreased dry powder, and grinding by using precooled liquid nitrogen, after grinding, placing the dry powder in a reactor, adding 10 times the volume of sodium dodecyl sulfate to the reactor, mixing thoroughly, then adding 3 times the volume of phenol to obtain a mixture, letting the mixture standing for 10 hours, then performing extraction on the mixture in the reactor, discarding an organic phase and an supernatant, and collecting a dry powder precipitate, drying the dry powder precipitate in a blast drying oven at 60° C. for 20 minutes; and
placing the dry powder precipitate into a reaction tube, then adding 12 times the mass of the dry powder precipitate of 95% ethanol for soaking, soaking for 48 hours, and after soaking, placing the dry powder precipitate in a blast drying oven at 60° C. for 50 minutes to obtain the degreased and impurity-removed gardenia dry powder.

6. The method for preparing gardenia yellow pigment as described in claim 1, wherein the pigment adsorption resin comprises the following raw materials in parts by weight:
polyvinyl alcohol: 10-20 parts;
maleic rosin acid ethylene glycol acrylate: 20-60 parts;
initiator: 1-10 parts;
pore-forming agent: 1-5 parts;
surfactant: 1-15 parts;
deionized water: 100-120 parts;
hexamethylphosphoramide: 10-15 parts;
wherein the initiator is azobisisobutyronitrile, the surfactant is sodium dodecylbenzenesulfonate, and the pore-forming agent is a 1:1 mixture of polyvinylpyrrolidone and toluene; and
wherein a method for preparing the pigment adsorption resin comprises:
placing maleic rosin acid ethylene glycol acrylate, polyvinyl alcohol, and initiator in a flask as an oil phase;
placing deionized water, hexamethylphosphoramide, and surfactant in the flask as a water phase, then mixing and stirring the oil phase and water phase under nitrogen protection at a stirring speed of 200-250 r/min, and heating in an air bath to 85-90° C. for 2 hours;
adding the pore-forming agent to the flask and continuing reacting for 1 hour, then adjusting a pH of reaction mixture to 6.0-6.5 with 0.5 mol/L malic acid, cooling to room temperature, and adding 3 times a volume of anhydrous ethanol to the flask for extraction for 2 hours to remove residual initiators and pore-forming agents, finally, using rotary evaporation to obtain the rosin-based pigment adsorption resin.

7. The method for preparing gardenia yellow pigment as described in claim 1, wherein a method for loading the crude pigment extract onto the column for adsorption, eluting with a 45% ethanol solution, and separating the pigment solution and impurity solution comprises:
taking the pigment adsorption resin, adding equal volumes of oxalyl chloride and anhydrous ethanol to the pigment adsorption resin, and mechanically stirring at 100-120 r/min for 30 minutes, under an argon atmosphere, adding anhydrous aluminum chloride and reacting at room temperature for 4 hours;
adding equal volumes of ethanol to wash and filter 3-5 times, then adding an equal volume of ethanol to soak overnight, afterward, drying for 30 minutes, placing the pigment adsorption resin into a flask, adding 4 times the weight of dichloroethane, and stirring mixture, slowly adding 90% concentrated sulfuric acid until a pH reaches 4.5-5; and
heating the flask in a water bath to 80° C. and reacting for 4 hours, ater the reaction, transferring the pigment adsorption resin from the flask into a chromatography column and performing reverse washing with ultrapure water 3-5 times until neutral.

8. The method for preparing gardenia yellow pigment as described in claim 7, wherein the method for loading the crude pigment extract onto the column for adsorption, eluting with a 45% ethanol solution, and separating the pigment solution and impurity solution further comprises:
wet packing the pigment adsorption resin onto a column, then loading the crude pigment extract onto the column for adsorption for 6 hours, setting a sample flow rate of the crude pigment extract as 5 ml/min, setting a weight ratio of the crude pigment extract to the pigment adsorption resin as 5:2, eluting with a 45% ethanol solution to separate the pigment solution and impurity solution.

9. The method for preparing gardenia yellow pigment as described in claim 1, wherein the method further comprises:
taking the impurity solution, preparing a purification extracting agent, and mix the purification extracting agent with the impurity solution at a volume ratio of 10:3, then, extracting and purifying chlorogenic acid from the impurity solution, setting an extraction time as 3-10 minutes, and then using a stripping agent for 2-10 stages of countercurrent stripping to obtain a gardenia glycoside solution that separates chlorogenic acid.

10. The method for preparing gardenia yellow pigment as described in claim 9, wherein, when extracting and purifying chlorogenic acid from the impurity solution, the purification extracting agent is a mixture of acetone and cocoamidopropyl betaine in a 5:1 weight ratio; an the stripping agent is a mixture of ethanol and malic acid in a 4:1 volume ratio.

11. A gardenia yellow pigment, wherein the gardenia yellow pigment is obtained by the method of claim 1.
